(19) United States
(12) Patent Application Publication
(10) Pub. No.: US 2025/0010626 A1
(43) Pub. Date: Jan. 9, 2025

(54) CARTRIDGE AND LIQUID EJECTION APPARATUS

(71) Applicant: CANON KABUSHIKI KAISHA, Tokyo (JP)

(72) Inventors: KEISUKE IINUMA, Kanagawa (JP); TATSUO NANJO, Kanagawa (JP); WATARU TAKAHASHI, Kanagawa (JP); HIROKI HAYASHI, Kanagawa (JP)

(21) Appl. No.: 18/762,423

(22) Filed: Jul. 2, 2024

(30) Foreign Application Priority Data
Jul. 7, 2023 (JP) 2023-112111

(51) Int. Cl. B41J 2/175

(52) U.S. Cl. CPC B41J 2/17513; B41J 2/17553; B41J 2/17559; B41J 2/17563

(57) ABSTRACT

Provided are a cartridge and a liquid ejection apparatus that can suppress the increase in size of the liquid ejection apparatus. To this end, in the cartridge, a plurality of storage chambers including absorbers are linearly arranged along the arrangement direction of the ejection ports in the ejection port row.

### BACKGROUND OF THE INVENTION

### Field of the Invention

The present invention relates to a cartridge that is used in a liquid ejection apparatus and contains a liquid and the liquid ejection apparatus.

### Description of the Related Art

There has been known as a conventional ink cartridge a configuration as disclosed in Japanese Patent Laid-Open No. 2008-260199. The ink cartridge according to Japanese Patent Laid-Open No. 2008-260199 includes a case that contains an ink and a printing element substrate that ejects the ink. The inside of the case is sectioned into three regions adjacent to each other, and absorbers that hold different inks are stored in the sections, respectively. The ink held by each absorber passes through a filter and an ink channel and is supplied to the printing element substrate provided in a lower portion of the case. On the printing element substrate, an ejection port row in which multiple ejection ports form a row is provided in a direction crossing a scanning direction of the ink cartridge, and multiple ejection port rows corresponding to ink colors are arrayed in the scanning direction.

The absorbers stored inside the case according to Japanese Patent Laid-Open No. 2008-260199 are arranged in the three regions adjacent to each other, and a configuration in which the multiple absorbers are arrayed in the scanning direction is applied. In such a configuration, a width of the case in the scanning direction is wide, and there is a concern of the size increase of the apparatus.

### SUMMARY OF THE INVENTION

Therefore, the present invention provides a cartridge and a liquid ejection apparatus that can suppress the size increase of the apparatus.

To this end, a cartridge of the present invention includes: a printing element substrate that includes a first ejection port row in which multiple ejection ports that eject a first liquid are arrayed in a first direction and a second ejection port row in which multiple ejection ports that eject a second liquid are arrayed in the first direction, the second ejection port row being arranged in a second direction crossing the first direction with respect to the first ejection port row; a first storage chamber that contains the first liquid; a second storage chamber that contains the second liquid; a first channel that can supply the first liquid in the first storage chamber to the first ejection port row; and a second channel that can supply the second liquid in the second storage chamber to the second ejection port row, in which widths of the first storage chamber and the second storage chamber in the second direction are equal to each other, and the first storage chamber and the second storage chamber are arrayed along the first direction.

According to the present invention, it is possible to provide a cartridge and a liquid ejection apparatus that can suppress the size increase of the apparatus.

Further features of the present invention will become apparent from the following description of exemplary embodiments with reference to the attached drawings.

### BRIEF DESCRIPTION OF THE DRAWINGS

FIG. 1 is a schematic view illustrating an ink jet printing apparatus;

FIG. 2 is an exterior perspective view illustrating a cartridge;

FIG. 3 is an exploded perspective view of the cartridge;

FIG. 4 is a perspective view illustrating an extracted and modeled space as a channel;

FIGS. 5A to 5C are perspective views illustrating an extracted and modeled space as a channel;

FIGS. 6A to 6C are perspective views illustrating an extracted and modeled space as the channel;

FIGS. 7A to 7C are perspective views illustrating an extracted and modeled space as the channel;

FIGS. 8A to 8C are perspective views illustrating an extracted and modeled space as the channel;

FIG. 9 is a top view illustrating a case;

FIG. 10 is a top view illustrating the case to which a filter is welded;

FIG. 11 is a top view illustrating the case in which an absorber is inserted;

FIG. 12 is a top view illustrating a model extracting a space of the channel;

FIG. 13 is a diagram illustrating a conventional cartridge;

FIG. 14 is a top view illustrating a model extracting a space of a conventional channel;

FIG. 15 is a diagram illustrating a model extracting a space of the conventional channel and an absorber; and

FIG. 16 is a top view illustrating a part of the model extracting the space of the channel and the absorber.

### DESCRIPTION OF THE EMBODIMENTS

Embodiments of the present invention are described below with reference to the drawings.

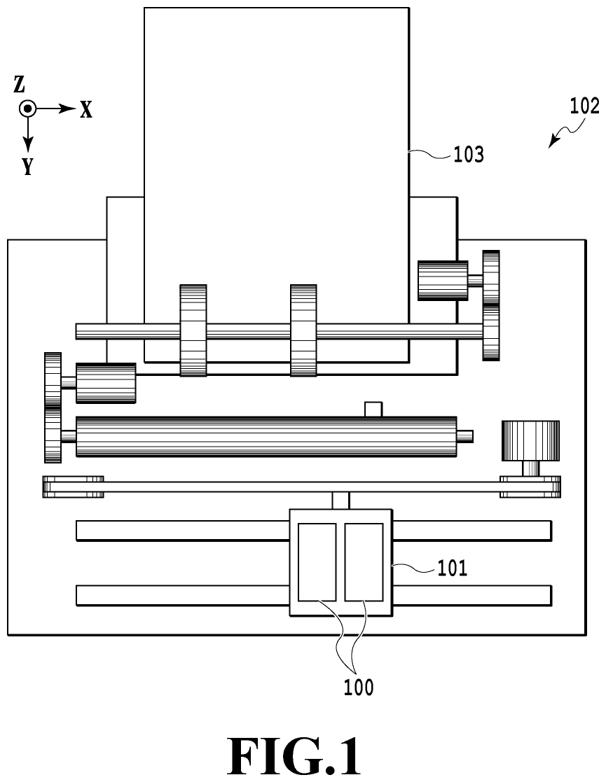

FIG. 1 is a schematic view illustrating an ink jet printing apparatus (hereinafter, also referred to as a liquid ejection apparatus) 102 to which the present embodiment is applicable. In FIG. 1, an X direction indicates a scanning direction of a carriage, a Y direction indicates a conveyance direction of a printing medium, and a Z direction indicates a vertical up direction. Note that, the subsequent drawings describing only the cartridge also illustrate an XYZ axis same as that in FIG. 1 based on a case where the cartridge is mounted in the printing apparatus. The liquid ejection apparatus 102 is formed such that a cartridge 100 can be mounted on a carriage 101 and performs printing with the cartridge 100 mounted on the carriage 101 ejecting a liquid (hereinafter, also referred to as an ink) while moving relatively to a printing medium 103. That is, the liquid ejection apparatus 102 is a serial type printing apparatus. In the ejection, the liquid is ejected from the cartridge 100 while the carriage 101 reciprocally moves in the X direction. An image is formed on the printing medium 103 by conveying the printing medium 103 by a predetermined amount in a direction (the Y direction) orthogonal to a direction of the reciprocal movement of the carriage 101 according to the ejection of the liquid from the cartridge 100.

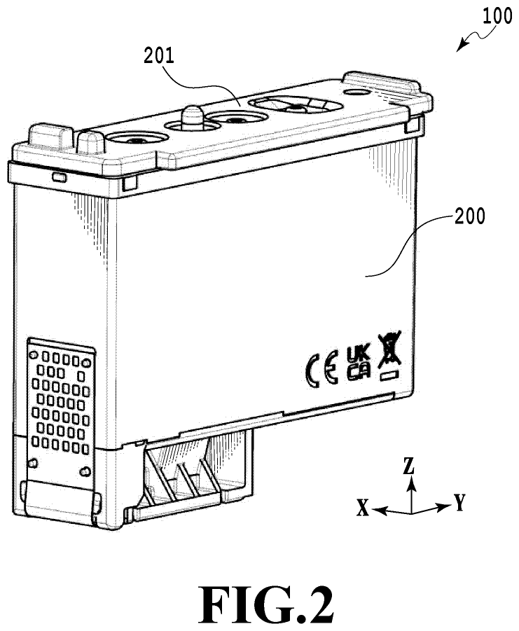

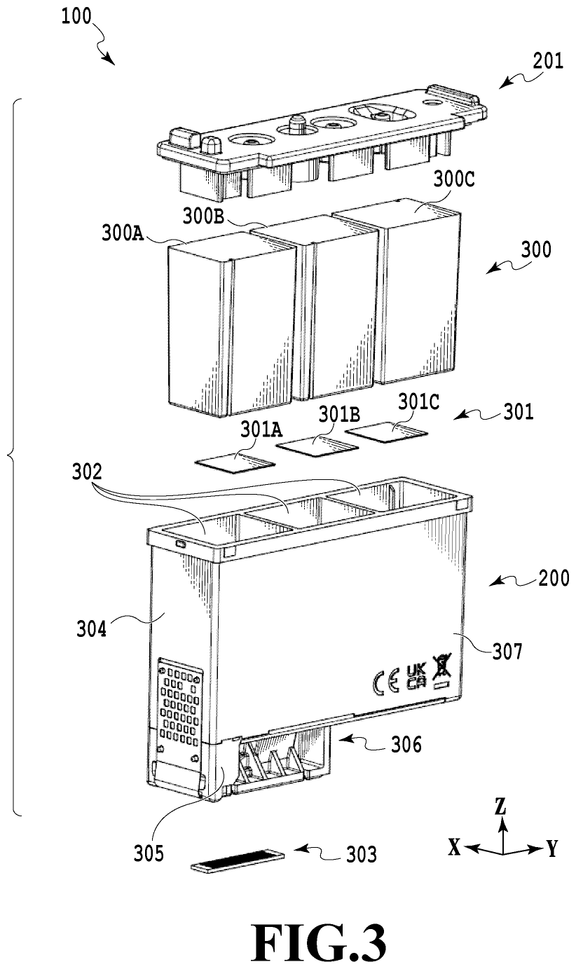

FIG. 2 is an exterior perspective view illustrating the cartridge 100, and FIG. 3 is an exploded perspective view of the cartridge 100. The cartridge 100 includes a printing element substrate 303 to eject the liquid, a case 200 in which a storage chamber 302 that contains the liquid is formed, and a lid 201. In the storage chamber 302, a filter 301 and an absorber 300 that holds the liquid contained in the storage chamber 302 are stored. The liquid held by the absorber 300 is supplied to an ejection port of the printing element substrate 303 through a channel portion (not illustrated in FIGS. 2 and 3) communicating with the storage chamber 302. In the present embodiment, the absorber 300 is inserted in the storage chamber 302 as a negative pressure generation unit to hold the liquid; however, it is also possible to hold the liquid similarly in a mode employing a pressure control unit, a circulation unit, and the like as the negative pressure generation unit.

The liquid contained in the storage chamber 302 is generally a color ink, and inks for cyan, magenta, and yellow are each contained in a corresponding storage chamber. Note that, although a configuration in which the cartridge 100 includes the three storage chambers 302 is described as an example in the present embodiment, it is not limited thereto, and the present embodiment is also applicable to a case where there are four or more storage chambers 302. For example, the same idea applies to a four-color-integral cartridge including black.

FIG. 3 illustrates three absorbers 300A, 300B, and 300C for cyan, magenta, and yellow. The absorber 300 desirably has a shape close to a cube for the supplying performance of the liquid. Note that, in a case where the size of the absorber 300 is changed taking into consideration of the amount of the liquid contained, the shape is preferably extended in a gravity direction (the Z direction). In a case where the size of the absorber 300 is increased in the scanning direction (the X direction), a width of the cartridge 100 is increased, and it leads the size increase of the whole apparatus. Additionally, in a case where the size of the absorber 300 is increased in an array direction of the ejection ports (the Y direction), a channel from the absorber 300 to the printing element substrate 303 is increased in length, and a flow resistance during the liquid supply is increased, which is not preferable.

The absorber 300 is formed of a fiber material, a porous body, or the like and can hold the ink therein by developing capillary force. The absorber 300 is stored in the storage chamber 302 of the case 200 while it is in contact with the filter 301 as a dust trap, and the liquid in the absorber 300 is supplied to the printing element substrate 303 through the filter 301 and the channel portion.

The printing element substrate 303 is an ejection unit that ejects the ink and is arranged on a bottom surface at a lower portion of the case 200 in the gravity direction. The printing element substrate 303 is arranged near lower portions of the absorber 300A and the absorber 300B and is in a position distant from the absorber 300C. The case 200 includes a box portion 307 in which the storage chamber 302 is formed and a channel formation portion 306 projecting from the box portion 307 in a −Z direction, and the printing element substrate 303 is attached on a −Z direction side of the channel formation portion 306. That is, the printing element substrate 303 is arranged on a bottom surface of the whole cartridge 100, and in the liquid ejection, the liquid is ejected in a state of being close to the printing medium 103.

The lid 201 is arranged to close an opening of the case 200 and sections the storage chamber 302 in which the absorber 300 is stored. A not-illustrated air communication port is provided in the lid 201, and it is possible to take the air from the outside to the inside by a consumed amount of the liquid in the absorber 300 by the ejection.

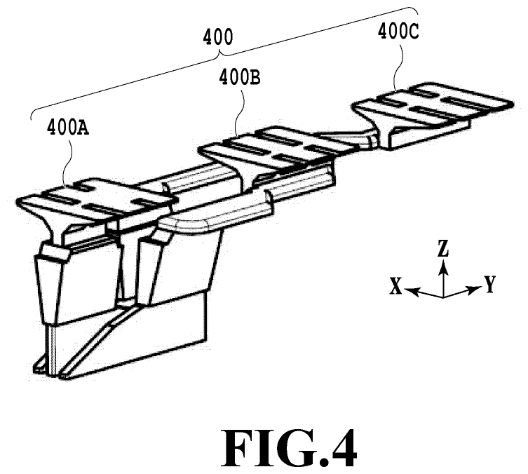

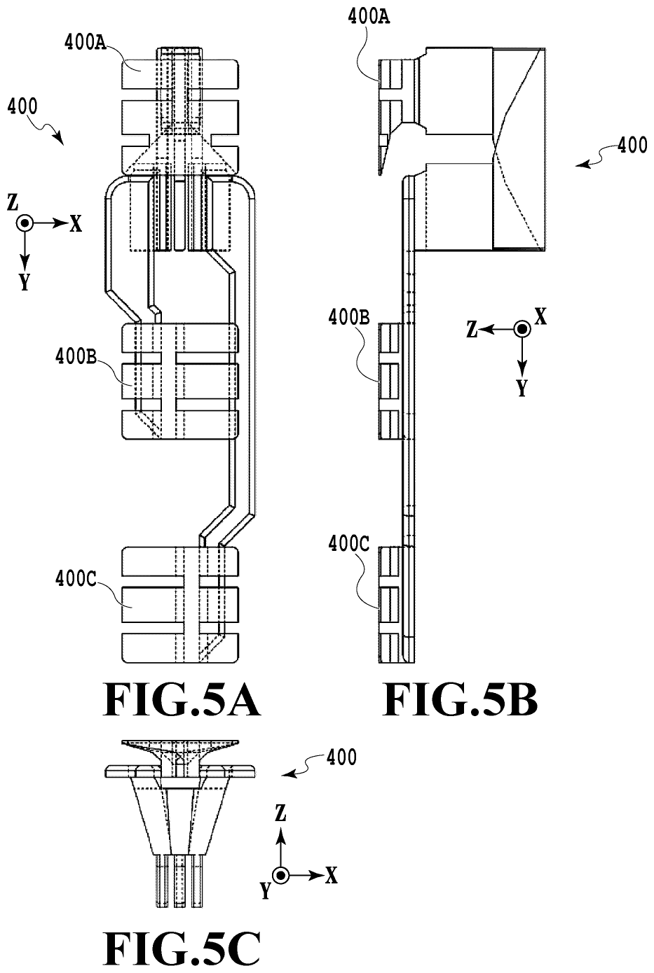

FIG. 4 is a perspective view extracting and modeling a space as the channel of the liquid in the case 200 and illustrating as a channel portion 400. FIG. 5A is a top view of the channel portion 400, FIG. 5B is a front view of the channel portion 400, and FIG. 5C is a side view of the channel portion 400. The channel portion 400 is a model extracting the channel of the ink and includes channels (400A, 400B, and 400C) for three colors. The channels are independent from each other, and to be specific, as illustrated in FIG. 5A, the channel 400A, the channel 400B, and the channel 400C are arranged in the Y direction in this order. Such a channel portion 400 is formed so as to be able to supply the liquid in the storage chamber 302 to the printing element substrate 303.

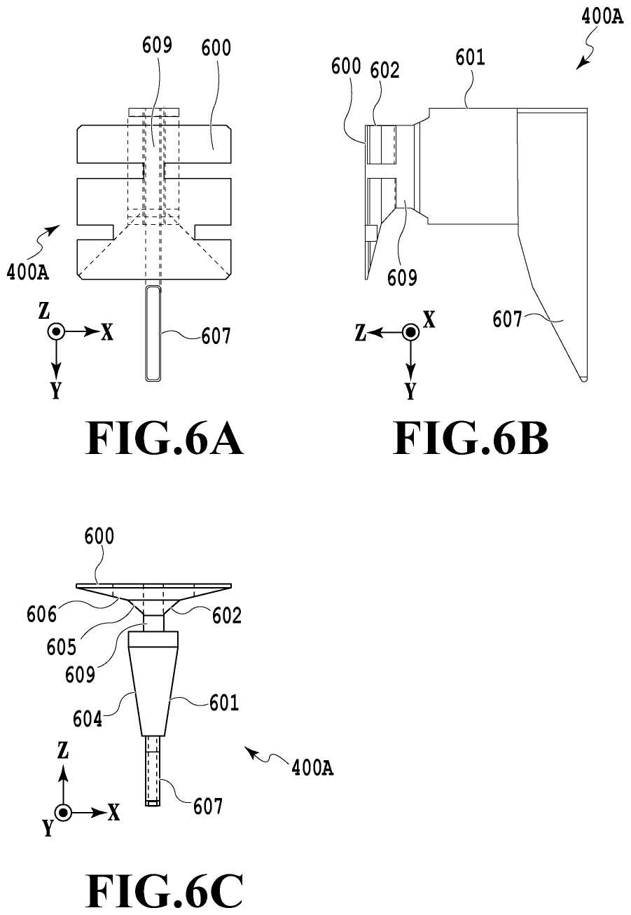

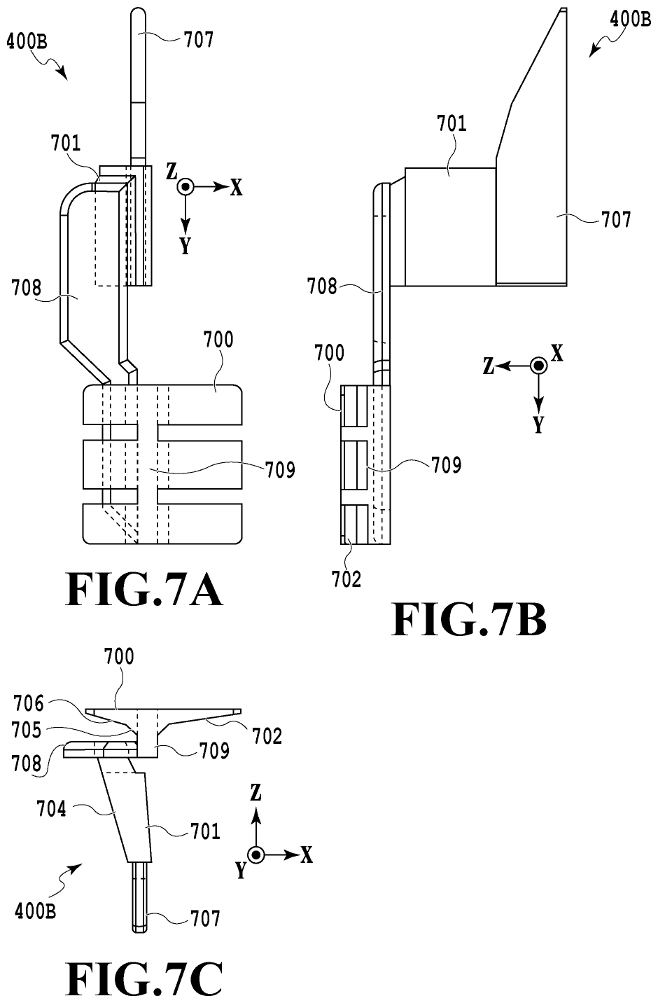

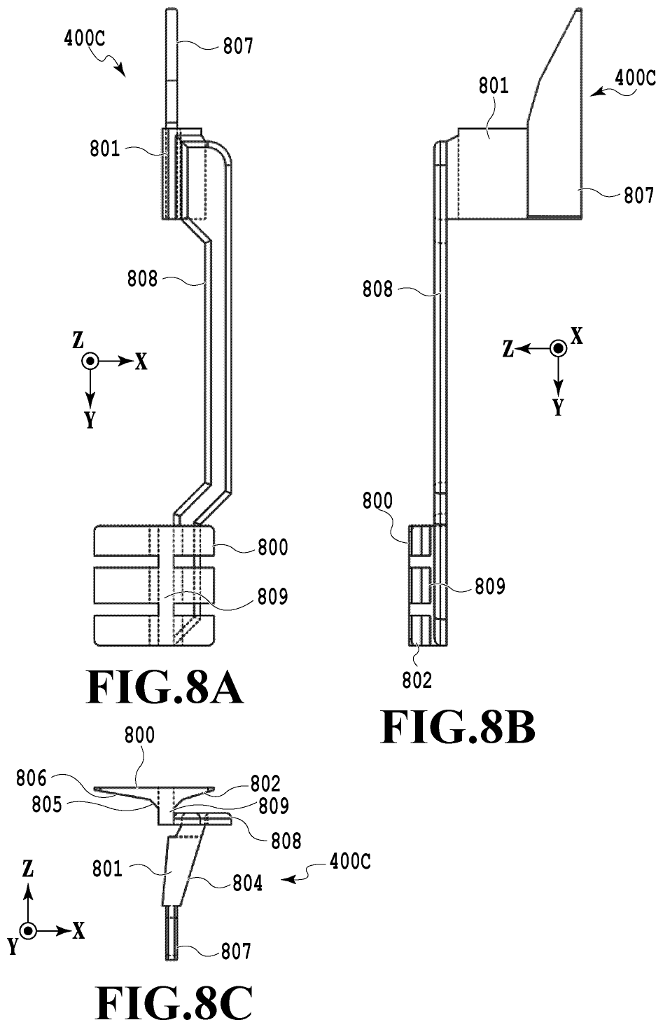

FIG. 6A is a top view of the channel 400A, FIG. 6B is a side view of the channel 400A, and FIG. 6C is a front view of the channel 400A. FIG. 7A is a top view of the channel 400B, FIG. 7B is a side view of the channel 400B, and FIG. 7C is a front view of the channel 400B. FIG. 8A is a top view of the channel 400C, FIG. 8B is a side view of the channel 400C, and FIG. 8C is a front view of the channel 400C.

As illustrated in FIGS. 6A to 6C, the channel 400A includes a first opening portion 600 provided with a filter 301A, a first reservoir portion 601, a second reservoir portion 602, a second opening portion 609 connecting the first reservoir portion 601 and the second reservoir portion 602 with each other, and a connection channel 607 connected to the printing element substrate 303. The first reservoir portion 601 and the second reservoir portion 602 are wider than other regions and can reserve air bubbles generated by ejection and the like.

The first opening portion 600 is an opening that receives the liquid that passes through the filter 301A and positioned on a bottom surface of the storage chamber 302 containing the absorber 300A. The first reservoir portion 601 and the second reservoir portion 602 are each formed to have a space that widens as it goes upward in a vertical direction. To be specific, in the first reservoir portion 601, a tapered portion 604 is provided to obtain the space that widens as it goes upward in the vertical direction, and in the second reservoir portion 602, first and second tapered portions 605 and 606 are provided. With such a configuration, it is possible to collect the air bubbles generated in the channel by using buoyancy and to keep a distance from the ejection port.

In order to move the air bubbles to a filter side in a narrow space, two stages of tapered portions, which are the first tapered portion 605 and the second tapered portion 606, are formed in the second reservoir portion 602. In order to avoid a meniscus while moving the air bubbles upward, an angle of the first tapered portion 605 is preferably equal to or greater than 10 degrees and equal to or smaller than 80 degrees, more preferably equal to or greater than 20 degrees and equal to or smaller than 60 degrees, and even more preferably equal to or greater than 30 degrees and equal to or smaller than 50 degrees with respect to a horizontal direction. Additionally, in the second reservoir portion 602, a flow velocity of the ink flowing during a recovery operation such as suction needs to be increased by shortening a distance between the space of the second reservoir portion 602 to the filter 301A. Therefore, an angle of the second tapered portion 606 is preferably equal to or smaller than 45 degrees, more preferably equal to or smaller than 30 degrees, and even more preferably equal to or smaller than 20 degrees with respect to the horizontal direction.

The first reservoir portion 601 is connected with the connection channel 607, and the connection channel 607 is connected with the ejection port row in the printing element substrate 303.

As illustrated in FIGS. 7A to 7C, the channel 400B includes a first opening portion 700 provided with a filter 301B, a first reservoir portion 701, a second reservoir portion 702, a second opening portion 709 connecting the first reservoir portion 701 and the second reservoir portion 702 with each other, and a connection channel 707.

The first opening portion 700 is an opening that receives the liquid that passes through the filter 301B and positioned on the bottom surface of the storage chamber 302 containing the absorber 300B. The first reservoir portion 701 provided in the vicinity of a nozzle row and the second reservoir portion 702 provided in the vicinity of the storage chamber are connected with each other through the second opening portion 709 and a horizontal portion 708 extending in the Y direction. Additionally, the first reservoir portion 701 and the second reservoir portion 702 are formed to have a space that widens as it goes upward in the vertical direction. In the first reservoir portion 701, a tapered portion 704 is provided to obtain the space that widens as it goes upward in the vertical direction, and in the second reservoir portion 702, first and second tapered portions 705 and 706 are provided. With such a configuration, it is possible to collect the air bubbles generated in the channel by using buoyancy and to keep a distance from the ejection port.

In order to move the air bubbles to a filter side in a narrow space, two stages of tapered portions, which are the first tapered portion 705 and the second tapered portion 706, are formed in the second reservoir portion 702. In order to avoid a meniscus while moving the air bubbles upward, an angle of the first tapered portion 705 is preferably equal to or greater than 10 degrees and equal to or smaller than 80 degrees, more preferably equal to or greater than 20 degrees and equal to or smaller than 60 degrees, and even more preferably equal to or greater than 30 degrees and equal to or smaller than 50 degrees with respect to the horizontal direction. Additionally, in the second reservoir portion 702, a flow velocity of the ink flowing during the recovery operation such as suction needs to be increased by shortening a distance between the space of the second reservoir portion 702 to the filter 301B. Therefore, an angle of the second tapered portion 706 is preferably equal to or smaller than 45 degrees, more preferably equal to or smaller than 30 degrees, and even more preferably equal to or smaller than 20 degrees with respect to the horizontal direction.

The first reservoir portion 701 is connected with the connection channel 707, and the connection channel 707 is connected with the ejection port row in the printing element substrate 303.

As illustrated in FIGS. 8A to 8C, the channel 400C includes a first opening portion 800 provided with a filter 301C, a first reservoir portion 801, a second reservoir portion 802, a second opening portion 809 connecting the first reservoir portion 801 and the second reservoir portion 802 with each other, and a connection channel 807.

The first opening portion 800 is an opening that receives the liquid that passes through the filter 301C and positioned on the bottom surface of the storage chamber 302 containing the absorber 300C. The first reservoir portion 801 provided in the vicinity of the nozzle row and the second reservoir portion 802 provided in the vicinity of the storage chamber are connected with each other through the second opening portion 809 and a horizontal portion 808 extending in the Y direction. Additionally, the first reservoir portion 801 and the second reservoir portion 802 are formed to have a space that widens as it goes upward in the vertical direction. In the first reservoir portion 801, a tapered portion 804 is provided to obtain the space that widens as it goes upward in the vertical direction, and in the second reservoir portion 802, first and second tapered portions 805 and 806 are provided. With such a configuration, it is possible to collect the air bubbles generated in the channel by using buoyancy and to keep a distance from the ejection port.

In order to move the air bubbles to a filter side in a narrow space, two stages of tapered portions, which are the first tapered portion 805 and the second tapered portion 806, are formed in the second reservoir portion 802. In order to avoid a meniscus while moving the air bubbles upward, an angle of the first tapered portion 805 is preferably equal to or greater than 10 degrees and equal to or smaller than 80 degrees, more preferably equal to or greater than 20 degrees and equal to or smaller than 60 degrees, and even more preferably equal to or greater than 30 degrees and equal to or smaller than 50 degrees with respect to the horizontal direction. Additionally, in the second reservoir portion 802, a flow velocity of the ink flowing during the recovery operation such as suction needs to be increased by shortening a distance between the space of the second reservoir portion 802 to the filter 301C. Therefore, an angle of the second tapered portion 806 is desirably equal to or smaller than 45 degrees, more desirably equal to or smaller than 30 degrees, and even more desirably equal to or smaller than 20 degrees with respect to the horizontal direction.

The first reservoir portion 801 is connected with the connection channel 807, and the connection channel 807 is connected with the ejection port row in the printing element substrate 303.

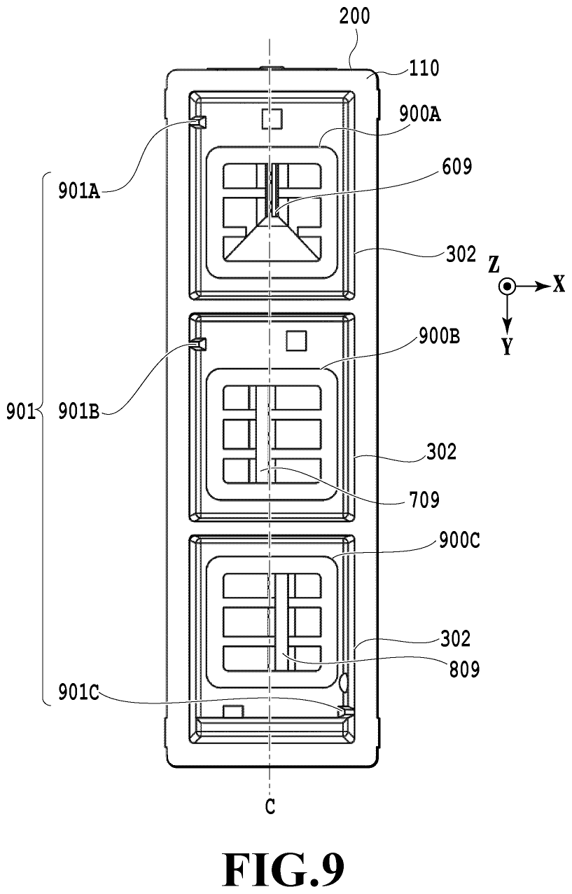

FIG. 9 is a top view illustrating the case 200 in a state in which the absorber 300 and the filter 301 are not contained. In the case 200, an opening 900A connected with the first opening portion 600 of the channel 400A, an opening 900B connected with the first opening portion 700 of the channel 400B, and an opening 900C connected with the first opening portion 800 of the channel 400C are provided on the same line extending in the Y direction. The openings 900A, 900B, and 900C are provided on a-Y direction side such that lengths of the channels 400A, 400B, and 400C in the Y direction are shortened, respectively. Additionally, in each storage chamber 302, a rib 901 is provided so as to allow for air communication also in a case where the absorber 300 is inserted. A rib 901A is provided in the storage chamber 302 corresponding to the opening 900A, a rib 901B is provided in the storage chamber 302 corresponding to the opening 900B, and a rib 901C is provided in the storage chamber 302 corresponding to the opening 900C.

In the storage chamber 302, the rib 901 is arranged in a position near the corresponding one of the openings 900A, 900B, and 900C. Thus, it is possible to suppress leaking of the liquid from the lid 201 even in a case where the air in the channel portion 400 or the air in a clearance between the absorber 300 and the storage chamber 302 is expanded due to an environmental change (temperature or air pressure).

The second opening portion 609 of the channel 400A is provided on a center line C of the case 200 in the X direction. Additionally, the second opening portion 709 of the channel 400B is provided to be deviated from the center line in a-X direction, and the rib 901B is arranged on a side close to the second opening portion 709 (a left side in FIG. 9). Moreover, the second opening portion 809 of the channel 400C is provided to be deviated from the center line in a +X direction, and the rib 901C is arranged on a side close to the second opening portion 809 (a right side in FIG. 9).

The amounts of the deviation of the second opening portion 709 and the second opening portion 809 with respect to the center line are desirably in a range of equal to or greater than 5% and equal to or smaller than 30%, more desirably equal to or greater than 10% and equal to or smaller than 25%, and even more desirably equal to or greater than 15% and equal to or smaller than 20% with respect to a width of the filter 301 in the X direction. In the present embodiment, the second opening portion 709 and the second opening portion 809 are deviated by +1 mm (8.3%) in the X direction with respect to the filter width of 12 mm. In a case where the deviation amount of the second opening portion 609 is excessively great, it is undesirable because it is difficult to supply the liquid from the opposite side of the direction in which the second opening portion 609 is deviated. Therefore, it is desirable to provide the second opening portions 609, 709, and 809 in positions near the center line like the present embodiment. The shapes of the second opening portions 609, 709, and 809 are each a vertically long slit shape in the present embodiment; however, another shape may be applied. For example, the shapes of the second opening portions 609, 709, and 809 may each be circular, oval, or the like.

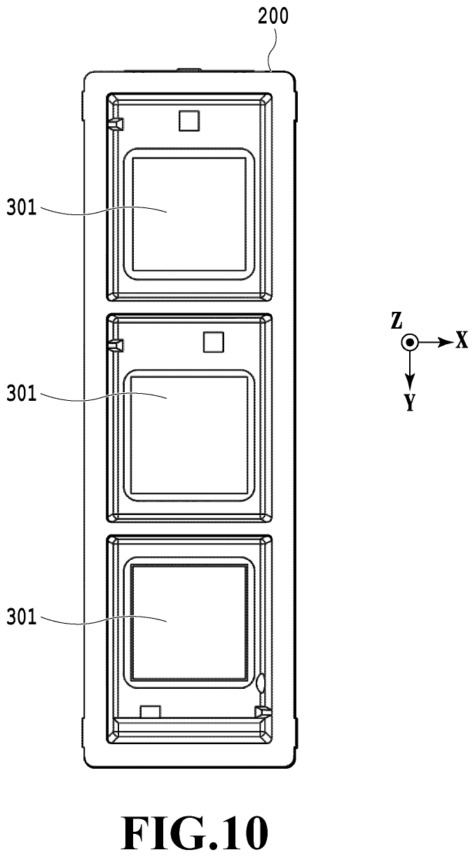

FIG. 10 is a top view illustrating the case 200 to which the filter 301 is welded. In the case 200, three filters 301 are welded to cover the second opening portions 609, 709, and 809 to suppress entering of dust into the second opening portions 609, 709, and 809. Note that, the filter 301 and the case 200 are not limited to be fixed by welding and may be fixed by adhesive and the like. In addition, the case 200 and the filter 301 may be formed integrally.

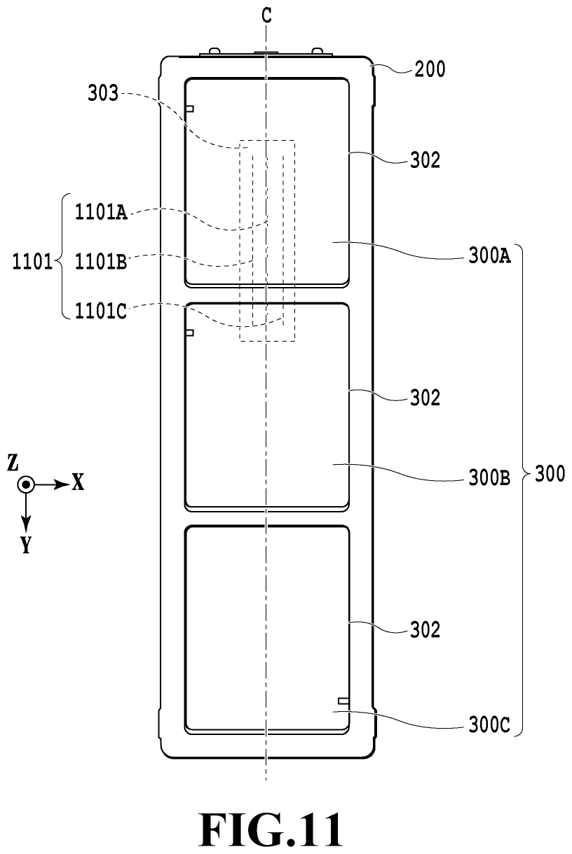

FIG. 11 is a top view illustrating the case 200 in which the absorber 300 is inserted. The absorber 300 formed of a fiber material, a porous body, or the like is inserted in a container portion 302 of the case 200 so as to be able to hold the liquid by the absorber 300. The liquid held by the absorber 300 is supplied to the printing element substrate 303 through the channel portion 400. FIG. 11 illustrates the printing element substrate 303 and an ejection port row 1101 with a broken line.

The liquid held by the absorber 300A is supplied to an ejection port row 1101A of the printing element substrate 303 through the channel 400A. The liquid held by the absorber 300B is supplied to an ejection port row 1101B of the printing element substrate 303 through the channel 400B. The liquid held by the absorber 300C is supplied to an ejection port row 1101C of the printing element substrate 303 through the channel 400C.

In the cartridge 100 of the present embodiment, three storage chambers 302 are formed by dividing the inside of the case 200 such that the absorbers 300A, 300B, and 300C are arranged in the Y direction along the center line C in the X direction. In a case where the cartridge 100 is mounted on the carriage 101 and performs scanning, the cartridge 100 is moved in the +X direction or the −X direction. In the printing element substrate 303, the ejection port row 1101 formed of the ejection ports arrayed in the Y direction is provided. That is, the absorbers 300A, 300B, and 300C are arranged in the same direction as an arraying direction of the ejection ports and are arranged along a direction crossing the scanning direction (in the present embodiment, orthogonal).

The case 200 is formed by molding resin. In the formation of the case 200, the case 200 is formed by molding the channel formation portion 306 (see FIG. 3) and the box portion 307 separately (primary molding) and thereafter joining the channel formation portion 306 and the box portion 307 with each other by secondary molding. Note that, in the secondary molding, a method in which a space is formed between the box portion 307 and the channel formation portion 306 put in contact with each other, and resin is poured into the space may be employed, or another connection method such as adhering may be employed. Thus, it is possible to form the channel in the case 200 by molding the channel formation portion 306 and the box portion 307 and thereafter joining the channel formation portion 306 and the box portion 307 with each other. Note that, although the storage chamber 302 are arrayed at equal intervals in the present embodiment, it may not be equal intervals.

The width of the cartridge 100 in the X direction is desirably equal to or smaller than 25 mm. In the present embodiment, since the three storage chambers 302 are arranged linearly in the Y direction, it is possible to make the width of the cartridge 100 narrower than that of a conventional cartridge. Note that, the width of the absorber 300 is desirably equal to or greater than 5 mm in terms of the supplying performance of the ink and the pouring performance of the ink. The width of the storage chamber 302 in the X direction is desirably equal to or greater than 5 mm as well.

Note that, the width of the cartridge 100 is desirably 10 mm to 25 mm, more desirably 13 mm to 23 mm, and even more desirably 15 mm to 21 mm. Regarding a ratio between the width in the X direction and a length in the Y direction of the case 200, since the supplying performance of the ink is better in a case where a cross-section of the absorber 300 in the XY plane is close to a square, the width in the X direction and the length in the Y direction preferably have a ratio of about 2:5 to 2:7 in a case where three storage chambers are formed like the present embodiment. The cartridge 100 of the present embodiment has the width in the X direction of 20 mm and the depth length in the Y direction of 70 mm.

In the absorber 300, as mentioned above, the cross-section in the XY plane is desirably close to a square, and one side is desirably 5 to 25 mm, more desirably 10 to 23 mm, and even more desirably 15 to 21 mm. Regarding a height of the absorber 300 in the Z direction, considering the liquid holding capability, the liquid can be used up better by extending the length in the Z direction than a case of extending the length in the X direction or the Y direction. However, the extension in the Z direction causes the size increase of the cartridge, and the size of an apparatus main body is also increased accordingly. Therefore, the height of the absorber 300 in the Z direction is desirably equal to or smaller than four times, more desirably equal to or smaller than three times, and even more desirably equal to or smaller than twice the width in the X direction or the length in the Y direction. In the absorber 300 of the present embodiment, the width in the X direction is 17 mm, the depth in the Y direction is 21 mm, and the height in the Z direction is 33 mm.

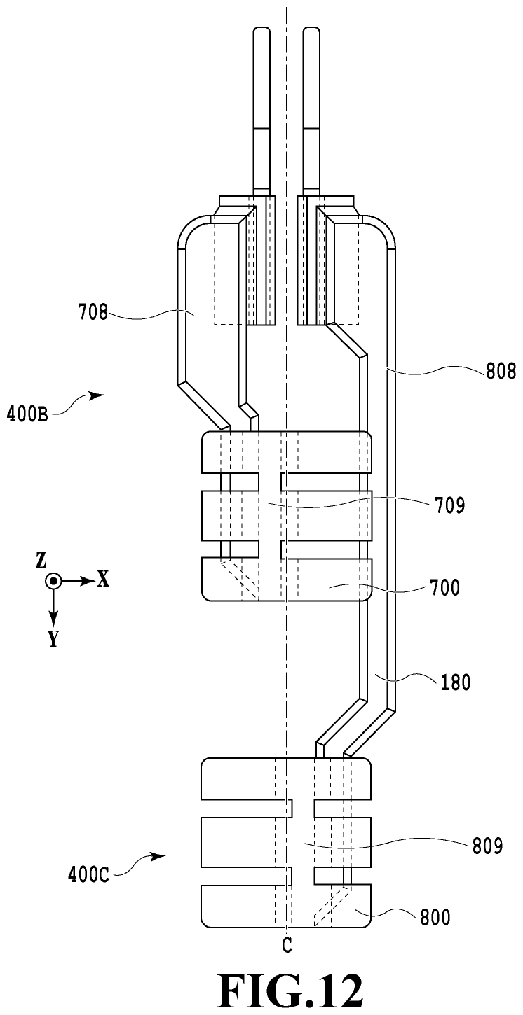

FIG. 12 is a top view illustrating the channel 400B and the channel 400C, in other words, a diagram illustrating a state of the channel portion 400 illustrated in FIG. 5A without the channel 400A. The second opening portion 709 of the channel 400B and the second opening portion 809 of the channel 400C are each arranged in a position deviated from the center of the case 200 in the X direction. In other words, the second opening portion 709 of the channel 400B is arranged to be deviated in the −X direction from the center of the case 200 in the X direction, and the second opening portion 809 of the channel 400C is arranged to be deviated in the +X direction from the center of the case 200 in the X direction. With the second opening portion 709 being arranged to be deviated as described above, it is possible to shorten the length of the horizontal portion 708 extending to the ejection port row in the Y direction in the channel 400B, and in addition, it is possible to widen the width of the horizontal portion 808 in the X direction in the channel 400C. Additionally, with the second opening portion 809 being arranged to be deviated in the opposite direction of the second opening portion 709 from the center, it is possible to shorten the length of the horizontal portion 808 of the channel 400C.

In the storage chamber 302, the corresponding absorber 300 is stored, and the filter 301 is provided between the absorber 300 and the channel portion 400 (see FIGS. 10 and 11). The filter 301 desirably has a great size to reduce a flow resistance. The size of the filter 301 is desirably equal to or greater than half a cross-sectional area of the absorber 300 in the XY plane, and the shape of the filter 301 is desirably close to a square. Thus, it is possible to increase the area in which the absorber 300 and the filter 301 are put in contact with each other and to use up the liquid better. To be specific, the size of the filter 301 is desirably equal to or smaller than 30% to 90%, more desirably 40% to 80%, and even more desirably 50% to 70% of the cross-sectional area of the absorber 300 in the XY plane. In the present embodiment, the size of the filter 301 has the width in the X direction of 12 mm and the depth in the Y direction of 12 mm (40% of the cross-sectional area of the absorber in the XY plane).

The channel 400A is formed below the filter 301A, the channel 400B is formed below the filter 301B, and the channel 400C is formed below the filter 301C (see FIGS. 9 and 10). Although the channel 400B is described below, the same applies to the channel 400A and the channel 400C.

Referring back to FIGS. 7A to 7C again. The liquid that passes through the filter 301B passes through the first opening portion 700 of the channel 400B and enters the second opening portion 709. In order to prevent stagnation in a space below the filter 301B, the second opening portion 709 is desirably provided near the central portion of the filter 301 in the X direction.

A space from the first opening portion 700 to the second opening portion 709 is the second reservoir portion 702 reserving the air bubbles. In the second reservoir portion 702, in order to make the air bubbles move upward easily, the width of the second opening portion 709 is narrow in the X direction to be narrower than a width of the first opening portion 700 in the X direction. However, in a case where the width of the second opening portion 709 in the X direction is excessively narrow, the flow resistance is increased. Therefore, the width of the second opening portion 709 in the X direction is desirably 10% to 60%, more desirably 10% to 40%, and even more desirably 10% to 20% of the width of the filter 301B in the X direction. In the present embodiment, the width of the second opening portion 709 in the X direction is 1.3 mm (10.8% of the width of the filter in the X direction).

Here, a configuration of the conventional cartridge is described as a comparative example of the present embodiment.

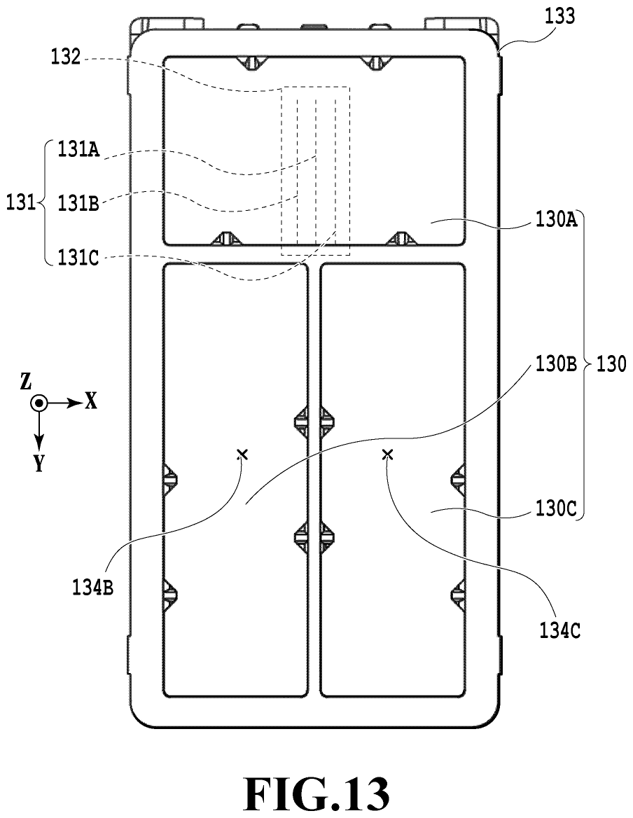

FIG. 13 is a diagram illustrating a conventional cartridge 133 disclosed in Japanese Patent Laid-Open No. 2008-260199. Three absorbers 130 are arranged in the cartridge 133, and each absorber holds the liquid. The cartridge 133 is mounted on a not-illustrated carriage, and the liquid is ejected while the cartridge 133 is moved in the X direction. The liquid is supplied to a printing element substrate 132 (displayed with a broken line) from the absorber 130 containing the liquid through the channel. The inside of the cartridge 133 is divided into T-shape, and the absorber 130 is provided in each of the divided sections. In the cartridge 133, an absorber 130B and an absorber 130C are arranged side by side in the X direction, which is the scanning direction. The liquid held by the absorber 130B is ejected from an ejection port row 131B, and the liquid held by the absorber 130C is ejected from an ejection port row 131C.

A position of a center of gravity 134B of the absorber 130B and a position of the ejection port row 131B are deviated from each other in the X direction, and a position of a center of gravity 134C of the absorber 130C and a position of the ejection port row 131C are deviated from each other in the X direction.

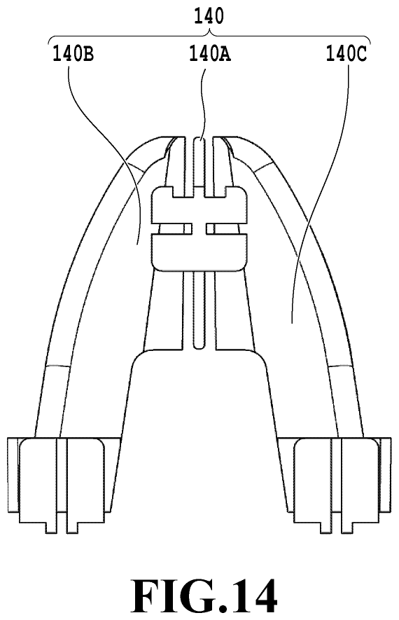

FIG. 14 is a top view illustrating a channel portion 140 modeled by extracting a channel space formed from the absorber 130 to an ejection port row 131. The liquid held by the absorber 130 is supplied to the ejection port row 131 of the printing element substrate 132 through the channel portion 140. The channel portion 140 includes three channels. A channel 140B connecting the absorber 130B and the ejection port row 131B with each other is arranged on a leftmost side in FIG. 14, a channel 140C connecting the absorber 130C and the ejection port row 131C with each other is arranged on a rightmost side, and a channel 140A connecting an absorber 130A and an ejection port row 131A with each other is arranged between the channels 140B and 140C.

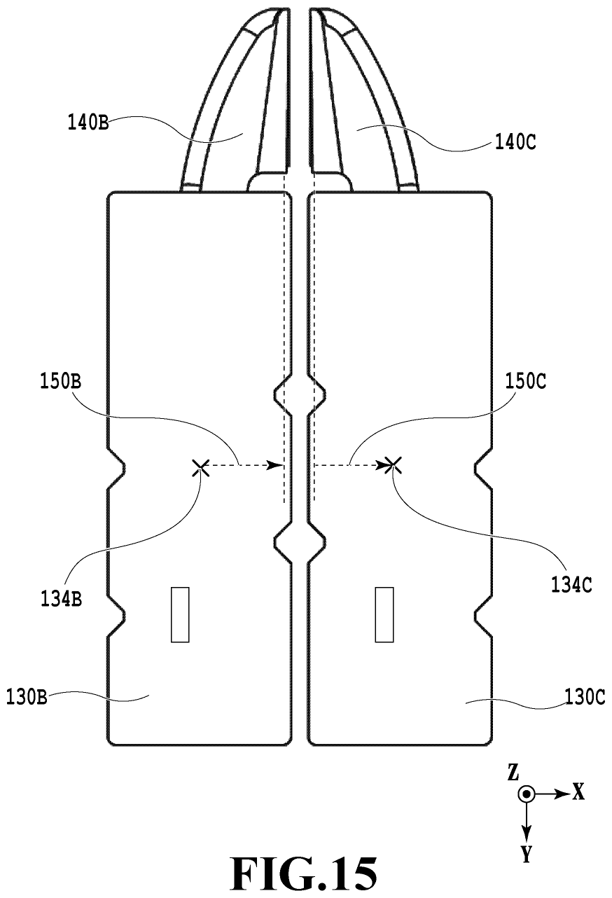

FIG. 15 is a diagram illustrating the channel 140B, the channel 140C, the absorber 130B, and the absorber 130C. FIG. 15 illustrates an extension line of each of the ejection port row 131B and the ejection port row 131C with a dotted line.

The ejection port row 131B (see FIG. 13) that ejects the liquid supplied from the channel 140B is provided to be deviated in the +X direction from the center of gravity 134B of the absorber 130B holding the liquid to be supplied to the channel 140B. Additionally, the ejection port row 131C (see FIG. 13) that ejects the liquid supplied from the channel 140C is provided to be deviated in the −X direction from the center of gravity 134C of the absorber 130C holding the liquid to be supplied to the channel 140C.

Here, a case where the cartridge 133 mounted on the carriage scans in the +X direction is considered. In this case, in a case where the carriage is accelerated, inertial force in the opposite direction of the scanning direction (the −X direction) acts on the liquids held by the absorber 130B and the absorber 130C. Additionally, in a case where the carriage is decelerated, inertial force in the opposite direction of the above direction (the +X direction) acts on the liquids held by the absorber 130B and the absorber 130C. In addition, in a case where the carriage scans in the −X direction, the inertial force in directions inverted from the above directions acts during acceleration and deceleration, respectively. In other words, in the absorber 130B and the absorber 130C, the force in the +X direction and the force in the −X direction act alternately every time the carriage scans, and the liquid held by the absorber 130 is oscillated in the +X directions every time. As a result, pressures of the liquids supplied to the channel 140B and the channel 140C are also varied, and this pressure change affects ejection states of the ejection port rows 131B and 131C. Such a pressure change is greater as the deviation amount between the center of gravity of the absorber 130 and the ejection port row 131 in the scanning direction (the X direction) is greater.

Additionally, in a case where the force in the +X direction acts on the cartridge 133, the ejection port row 131B is in a pressurized state, and the ejection port row 131C is in a depressurized state. In a case where the force in the −X direction acts on the cartridge 133, the ejection port row 131B is in the depressurized state, and the ejection port row 131C is in the pressurized state. Thus, since the states are different between pressurized and depressurized depending on the ink colors, there is a possibility that the quality of the image expressed on the printing medium is impaired.

Thus, hereinafter, a pressure that the liquid in the channel receives from the liquid held by the absorber is called an oscillation pressure.

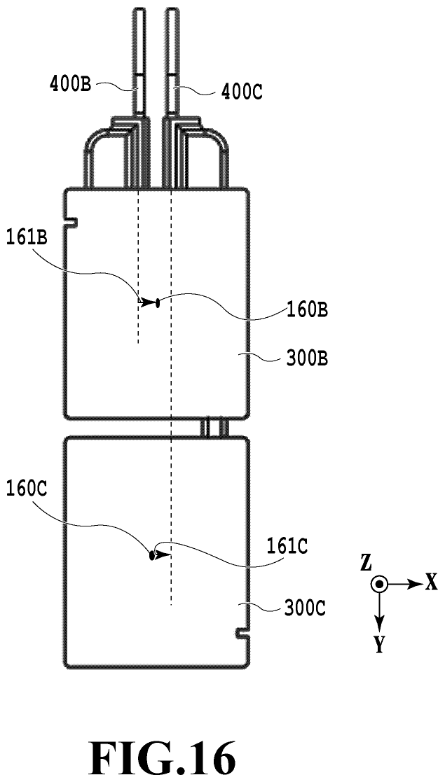

FIG. 16 is a top view illustrating the channel 400B, the channel 400C, the absorber 300B corresponding to the channel 400B, and the absorber 300C corresponding to the channel 400C in the cartridge 100 in the present embodiment. FIG. 16 illustrates an extension line of each of the ejection port row 1101B and the ejection port row 1101C (which are not illustrated) with a dotted line.

A case where the force in the +X direction acts on the cartridge 100 by the movement of the carriage 101 is described below as an example. The ejection port row 1101B that ejects the liquid supplied from the channel 400B is provided to be deviated in the −X direction from a center of gravity 160B of the absorber 300B holding the liquid supplied to the channel 400B. The liquid is supplied to the ejection port row 1101B from the absorber 300B through the channel 400B. Although the center of gravity 160B and the ejection port row 1101B are provided to be deviated from each other in the X direction, the deviation amount is less than that of the conventional example described in FIG. 15.

Additionally, the ejection port row 1101C that ejects the liquid supplied from the channel 400C is provided to be deviated in the +X direction from a center of gravity 160C of the absorber 300C holding the liquid supplied to the channel 400C. The liquid is supplied to the ejection port row 1101C from the absorber 300C through the channel 400C. Although the center of gravity 160C and the ejection port row 1101C are provided to be deviated from each other in the X direction, the deviation amount is less than that of the conventional example described in FIG. 15.

In a case where the cartridge is subjected to the force in the X direction, as illustrated in FIG. 16, an oscillation pressure 161B in a direction toward the center of gravity 160B of the absorber 300B acts on the ejection port row 1101B. Therefore, the ejection port row 1101B is in the depressurized state. Additionally, an oscillation pressure 161C in a direction from the center of gravity 160C of the absorber 300C acts on the ejection port row 1101C. Therefore, the ejection port row 1101C is in the pressurized state.

Note that, in the present embodiment, the absorbers 300A, 300B, and 300C are linearly arranged in the Y direction. With the absorbers being arranged linearly as above, it is possible to make the deviation amounts between the centers of gravity of the absorbers 300B and 300C and the ejection port rows 1101B and 1101C in the X direction less than that of the conventional configuration. Therefore, it is possible to reduce the oscillation pressure on the ejection port row, to suppress instability during the ejection, and to suppress the degradation of the printing quality.

Note that, in order to further reduce the oscillation pressure, a narrow width portion that is obtained by narrowing the channel width may be provided in a part of each of the channels 400B and 400C. With the narrowing, a resistance is generated, and it is possible to reduce the oscillation pressure. In a case where the width of the narrow width portion is excessively narrow, the flow resistance is increased in a case of supplying the ink. Therefore, in a case where the channel has a length of about 50 mm, the width is desirably equal to or greater than 1 mm, more desirably equal to or greater than 1.5 mm, and even more desirably equal to or greater than 2 mm. In addition, since a cartridge width is widened if the channel width of the narrow width portion is widened, the width is preferably equal to or smaller than 3 mm at a maximum.

Additionally, as a path from the absorber 300 to the ejection port row 1101 is longer, the effect of the oscillation pressure is greater; for this reason, the narrow width portion may be provided in only the channel 400C distant from the printing element substrate 303. Thus, it is possible to reduce the variation of the oscillation pressures in the channels 400A, 400B, and 400C, to stabilize the ejection, and to suppress the degradation of the printing quality.

As described above, in the cartridge, the positions of the centers of gravity of the multiple absorbers are arranged linearly in the array direction of the ejection ports in the ejection port row. This makes it possible to provide the cartridge and the liquid ejection apparatus that can suppress the size increase of the apparatus. In addition, it is possible to suppress instability during the ejection and to suppress the degradation of the printing quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-112111, filed Jul. 7, 2023, which is hereby incorporated by reference wherein in its entirety.

What is claimed is:

1. A cartridge, comprising:
a printing element substrate that includes a first ejection port row in which a plurality of ejection ports that eject a first liquid are arrayed in a first direction and a second ejection port row in which a plurality of ejection ports that eject a second liquid are arrayed in the first direction, the second ejection port row being arranged in a second direction crossing the first direction with respect to the first ejection port row;
a first storage chamber that contains the first liquid;
a second storage chamber that contains the second liquid;
a first channel that can supply the first liquid in the first storage chamber to the first ejection port row; and
a second channel that can supply the second liquid in the second storage chamber to the second ejection port row, wherein
widths of the first storage chamber and the second storage chamber in the second direction are equal to each other, and
the first storage chamber and the second storage chamber are arrayed along the first direction.

2. The cartridge according to claim 1, wherein
a center of gravity of the first storage chamber containing the liquid and a center of gravity of the second storage chamber containing the liquid are between an extension line of the first ejection port row and an extension line of the second ejection port row in the second direction.

3. The cartridge according to claim 2, wherein
the cartridge moves in the second direction while ejecting the first liquid and the second liquid from the printing element substrate.

4. The cartridge according to claim 2, wherein
the printing element substrate further includes a third ejection port row in which a plurality of ejection ports that eject a third liquid are arrayed in the first direction between the first ejection port row and the second ejection port row, and
the cartridge further comprises:
a third storage chamber that contains the third liquid; and
a third channel that can supply the third liquid in the third storage chamber to the third ejection port row.

5. The cartridge according to claim 4, wherein
widths of the first storage chamber, the second storage chamber, and the third storage chamber in the second direction are equal to each other, and
the first storage chamber, the second storage chamber, and the third storage chamber are arrayed along the first direction.

6. The cartridge according to claim 4, wherein
a center of gravity of the third storage chamber containing the liquid is on a vertical line in the third ejection port row.

7. The cartridge according to claim 1, wherein
the first channel and the second channel each include at least one reservoir portion that can reserve air bubbles in an orientation while using the cartridge.

8. The cartridge according to claim 7, wherein
the reservoir portion has a shape that widens as it goes upward in a vertical direction in the orientation while using the cartridge.

9. The cartridge according to claim 1, wherein
the first channel and the second channel each include a horizontal portion to move the liquid in a horizontal direction in an orientation while using the cartridge.

10. The cartridge according to claim 4, wherein
the first storage chamber, the second storage chamber, and the third storage chamber each include an absorber formed of a fiber material or a porous body to hold the liquid therein.

11. The cartridge according to claim 1, wherein
a width in the second direction is equal to or smaller than 25 mm.

12. The cartridge according to claim 4, wherein
a width of each of the first storage chamber, the second storage chamber, and the third storage chamber in the second direction is equal to or greater than 5 mm.

13. The cartridge according to claim 4, wherein
a filter is provided between the first storage chamber and the first channel, between the second storage chamber and the second channel, and between the third storage chamber and the third channel.

14. The cartridge according to claim 1, further comprising:
a case including a box portion in which the first storage chamber and the second storage chamber are formed and a channel formation portion in which the first channel and the second channel are formed, wherein
the case is formed by joining the box portion and the channel formation portion with each other.

15. The cartridge according to claim 14, wherein
the joining is performed by pouring resin into a clearance that is formed in a case where the box portion and the channel formation portion are put in contact with each other.

16. The cartridge according to claim 4, wherein
the first liquid is any one of inks of cyan, magenta, and yellow, the second liquid is any one of the inks of cyan, magenta, and yellow that is different from the first liquid, and the third liquid is any one of the inks of cyan, magenta, and yellow that is different from the first liquid and the second liquid.

17. A liquid ejection apparatus in which a cartridge can be mounted, the cartridge including:
a printing element substrate that includes a first ejection port row in which a plurality of ejection ports that eject a first liquid are arrayed in a first direction and a second ejection port row in which a plurality of ejection ports that eject a second liquid are arrayed in the first direction, the second ejection port row being arranged in a second direction crossing the first direction with respect to the first ejection port row;
a first storage chamber that contains the first liquid;
a second storage chamber that contains the second liquid;
a first channel that can supply the first liquid in the first storage chamber to the first ejection port row; and
a second channel that can supply the second liquid in the second storage chamber to the second ejection port row, wherein
widths of the first storage chamber and the second storage chamber in the second direction are equal to each other, and
the first storage chamber and the second storage chamber are arrayed along the first direction.
